(19) United States
(12) Patent Application Publication
(10) Pub. No.: US 2018/0037304 A1
(43) Pub. Date: Feb. 8, 2018

(54) Universal Paddle Board Step and Receiver

(71) Applicant: William C. Sinclair, Harrisburg, PA (US)

(72) Inventor: William C. Sinclair, Harrisburg, PA (US)

(21) Appl. No.: 15/666,333

(22) Filed: Aug. 1, 2017

Related U.S. Application Data
(60) Provisional application No. 62/370,981, filed on Aug. 4, 2016.

(51) Int. Cl. B63B 35/85; A01K 29/00; B63B 27/00

(52) U.S. Cl. CPC B63B 35/85; B63B 27/00; A01K 29/00; B63B 35/79

(57) ABSTRACT

A portable, lightweight, removable step device mounted to a paddle board to assist animals onto the board. The device is attached to a paddle board and can be placed on a board of any size or shape. The device may be secured without requiring any alteration to the paddle board or it may be affixed with more permanent means. Additionally, the device may pivot, allowing the paddler to adjust the position of the step device to accommodate the entry angle of the approaching animal and may fold up and out of the water to reduce water resistance.

### CROSS REFERENCE TO RELATED APPLICATIONS

This application claims benefit of priority from U.S. Provisional Patent Application No. 62/370,981 of William C. Sinclair, filed Aug. 4, 2016, entitled UNIVERSAL PADDLE BOARD STEP AND RECEIVER the entirety of which is incorporated herein by reference.

### STATEMENT REGARDING FEDERALLY SPONSORED RESEARCH/DEVELOPMENT

Not Applicable

### PARTIES TO A JOINT RESEARCH AGREEMENT

Not Applicable

### REFERENCE TO SEQUENCE LISTING, TABLE OR COMPUTER PROGRAM

Not Applicable

### BACKGROUND OF THE INVENTION

### Prior Art

The following is a tabulation of the prior art revealed during a patent search that may be relevant:

| | Kind | | |
|---|---|---|---|
| Patent/App. Number | Code | Issue/Publication Date | Patentee |
| 4,538,314 | N/A | Sep. 3, 1985 | Baranowski |
| 4,572,330 | N/A | Feb. 25, 1986 | Langevin |
| 4,768,618 | N/A | Sep. 6, 1988 | Ritten |
| 5,113,782 | N/A | May 19, 1992 | McCarty |
| 5,287,945 | N/A | Feb. 22, 1994 | Thurlow |
| 5,515,806 | N/A | May 14, 1996 | McCabe |
| 5,542,369 | N/A | Aug. 6, 1996 | Ingram |
| 6,769,378 | B1 | Aug. 3, 2004 | Dang |
| 6,792,887 | B1 | Sep. 21, 2004 | Baker |
| 6,941,889 | B1 | Sep. 13, 2005 | McCrocklin et al. |
| 7,011,036 | B1 | Mar. 14, 2006 | Hill |
| 8,596,212 | B2 | Dec. 3, 2013 | Perkins |
| 8,932,095 | B1 | Jan. 13, 2015 | Hudson |
| 2001/0027740 | A1 | Oct. 11, 2001 | Arias |
| 2002/0083881 | A1 | Jul. 4, 2002 | Arias |
| 2007/0240626 | A1 | Oct. 18, 2007 | Baker |
| 2013/0023169 | A1 | Jan. 24, 2013 | Morelli etal. |
| 2013/0247812 | A1 | Sep. 26, 2013 | Perkins |
| 2014/0230709 | A1 | Aug. 21, 2014 | Reynolds, Jr. |

The present invention relates to a universal step device that enables a paddler to assist an animal onto a paddle board, stand-up paddle board (SUP) or other similar paddling device. This portable apparatus is capable of being removeably attached to nearly any model of paddle board.

In recent years, paddle boarding has become a very popular water sport and many paddlers enjoy the company of their animals while on the water. A paddle board is capable of supporting a fairly heavy animal but the threat of capsizing makes it both difficult and dangerous for a paddler to help a service animal or pet climb onto the board.

Water craft stairs and ladders are well known in the art; however, the majority of these devices are designed with the human anatomy in mind, requiring the user to grasp rails or rungs to climb aboard the vessel. These designs are not suited and are generally incompatible with the anatomy and climbing abilities of pawed quadrupedal animals such as dogs and cats.

While there are several inventions directed to aiding animals in boarding boats, these devices are large, heavy and cumbersome designs that require a significant support structure. The weight and size of these designs make them impractical for use on a paddle board.

### BRIEF SUMMARY OF THE INVENTION

The present invention addresses the problems discussed above by offering a light weight, portable, and detachable step device that allows a paddler to assist an animal onto either side of a paddle board without compromising the stability of the craft.

The device is comprised of a paddle board step assembly and a paddle board receiver assembly. The receiver assembly is mounted and secured to the top face of the paddle board. The paddle board step assembly is pivotally mounted to this receiver assembly and secured with a fastener. A hinged step on the distal end of the step assembly rests below the water line, allowing an animal swimming beside the paddle board to step up as the paddler safely assists the dog onto the craft.

### BRIEF DESCRIPTION OF THE SEVERAL VIEWS OF THE DRAWINGS

FIG. 1 provides a perspective view of the invention affixed to a paddle board.

FIG. 2 provides a perspective view of the paddle board receiver assembly.

FIG. 3 provides a perspective view of the paddle board step assembly.

FIG. 4A is a top view of the receiver assembly platform and stabilizer.

FIG. 4B is a side view of the receiver assembly platform and stabilizer.

FIG. 5 is an exploded sectional view of the paddle board step assembly more clearly depicting the connector platform, riser and entry step.

FIG. 6A is a top view of the receiver assembly platform and stabilizer with holes for anchoring the platform to the paddle board.

FIG. 6B is a side view of the receiver assembly platform and stabilizer secured to the paddle board with anchors.

FIG. 7A is a top view of the receiver assembly platform and stabilizer secured to the paddle board with hook and loop tape.

FIG. 7B is a side view of the receiver assembly platform and stabilizer secured to the paddle board with hook and loop tape.

### REFERENCE NUMERALS

5 Paddle Board
10 Paddle Board Step Assembly
15 Connector Platform
20 Top Face of the Connector Platform
25 Bottom Face of the Connector Platform
30 Linkage Face of the Connector Platform
35 Riser
40 Linkage Face of the Riser
45 Tread Face of the Riser
50 Entry Step
55 Top Face of the Entry Step
60 Bottom Face of the Entry Step
65 Hinge
70 Connector Platform Pivot Point
75 Paddle Board Receiver Pivot Point
80 Pivot Point Fastener
85 Paddle Board Receiver Assembly
90 Receiver Assembly Platform
95 Top Face of the Receiver Assembly Platform
100 Bottom Face of the Receiver Assembly Platform
105 Stabilizer
110 Engagement Face of Stabilizer
115 Top Face of Stabilizer
120 Paddle Board Connection Points
125 Strapping
130 Drainage Holes
135 Non-Slip Material
140 Anchor Points
145 Anchor(s)
150 Frictional Anchoring Means

### DETAILED DESCRIPTION OF THE INVENTION

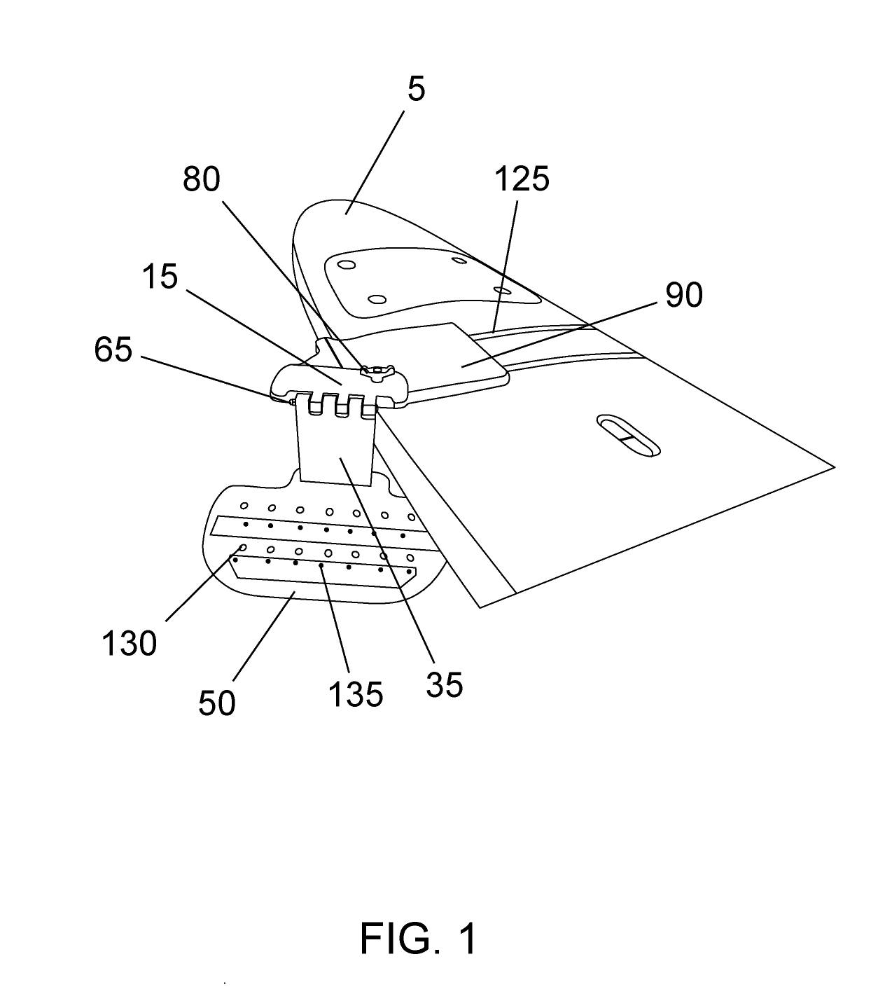

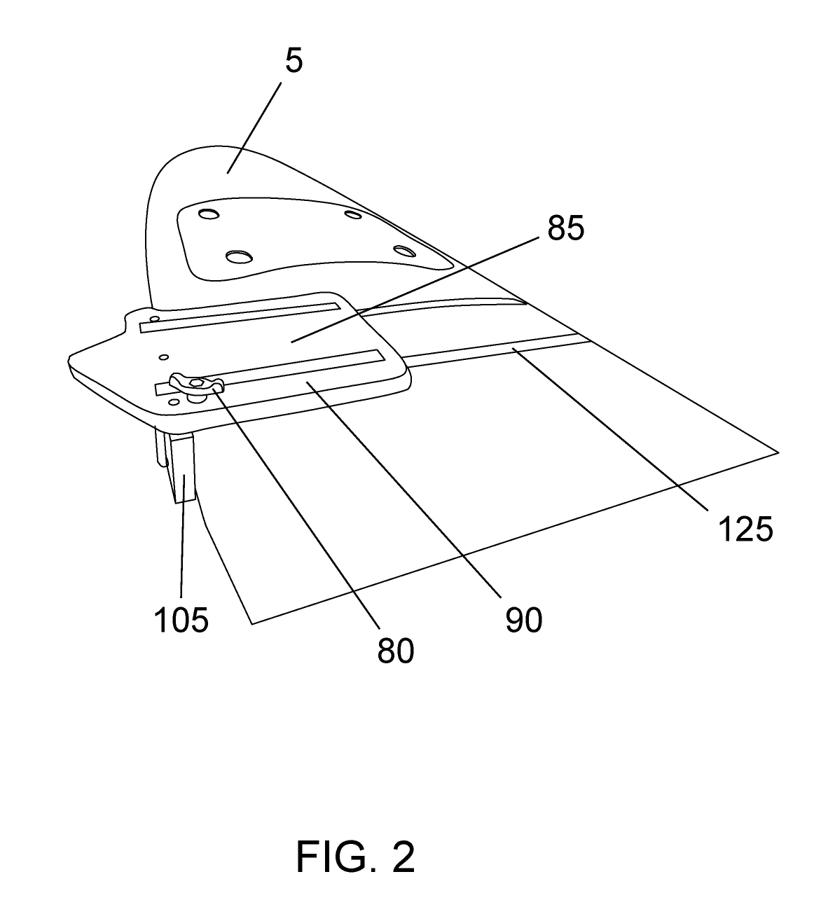

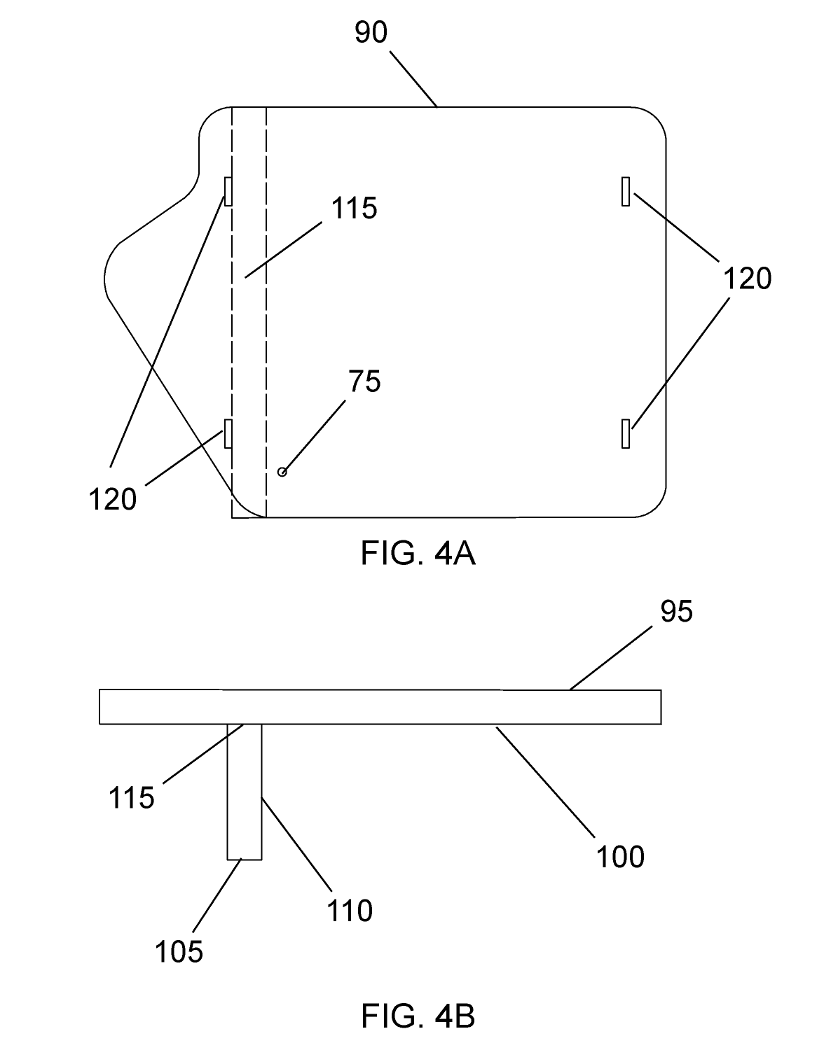

The present invention is comprised of a paddle board step assembly 10 and a paddle board receiver assembly 85. See FIGS. 1 through 3. Referring now to FIGS. 2, 4A and 4B, the paddle board receiver assembly 85 is comprised of a receiver assembly platform 90 and stabilizer 105. The receiver assembly platform 90 has a top face 95, bottom face 100, and an optional paddle board receiver pivot point 75. The stabilizer 105 has an engagement face 110 and top face 115. Because the stabilizer 105 and receiver assembly platform 90 may be manufactured separately or as one piece, the top face 115 of the stabilizer 105 either extends from or is mechanically affixed to the bottom face 100 of the receiver assembly platform 90 as shown in FIG. 4B.

Both the bottom face 100 of the receiver assembly platform 90 and the engagement face 110 of the stabilizer 105 are placed on the paddle board 5 such that one or both surfaces are frictionally engaged with the board as shown in FIG. 2. The paddle board receiver assembly 85 may be mounted on any size or shape of paddle board through a mechanical or frictional means. For the purpose of this application, wire, cables, flexible chains, cords, and filaments will be generally referred to as “straps” or “strapping.”

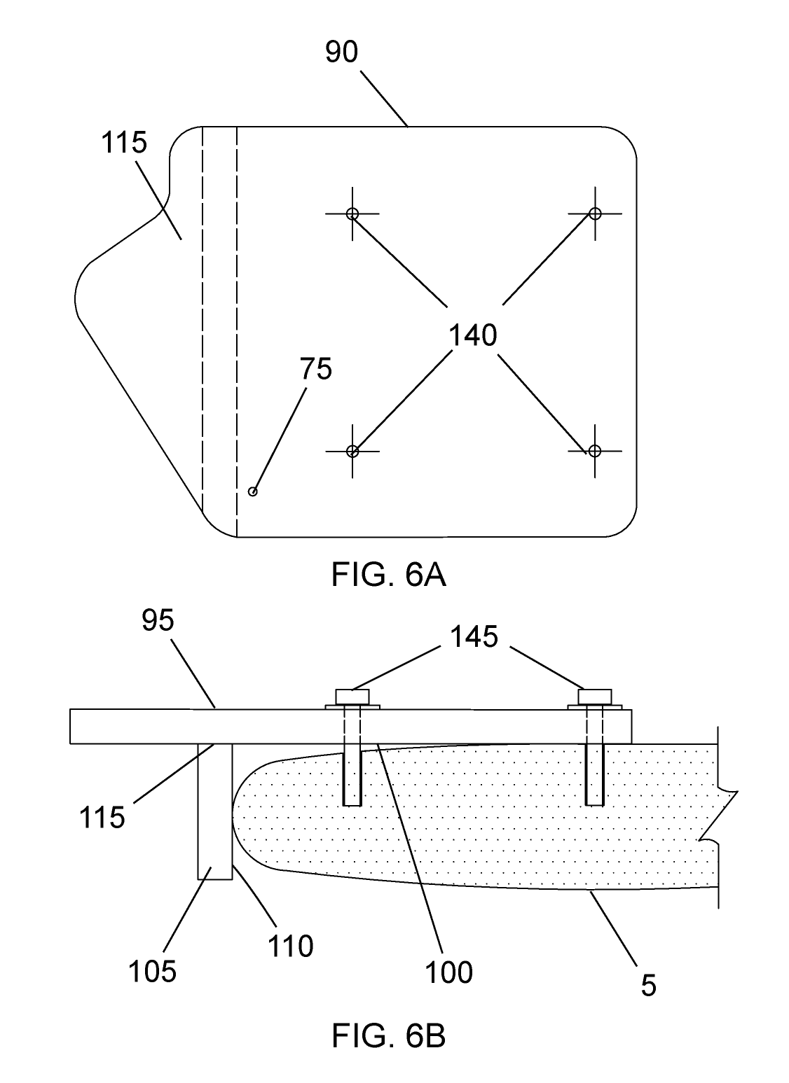

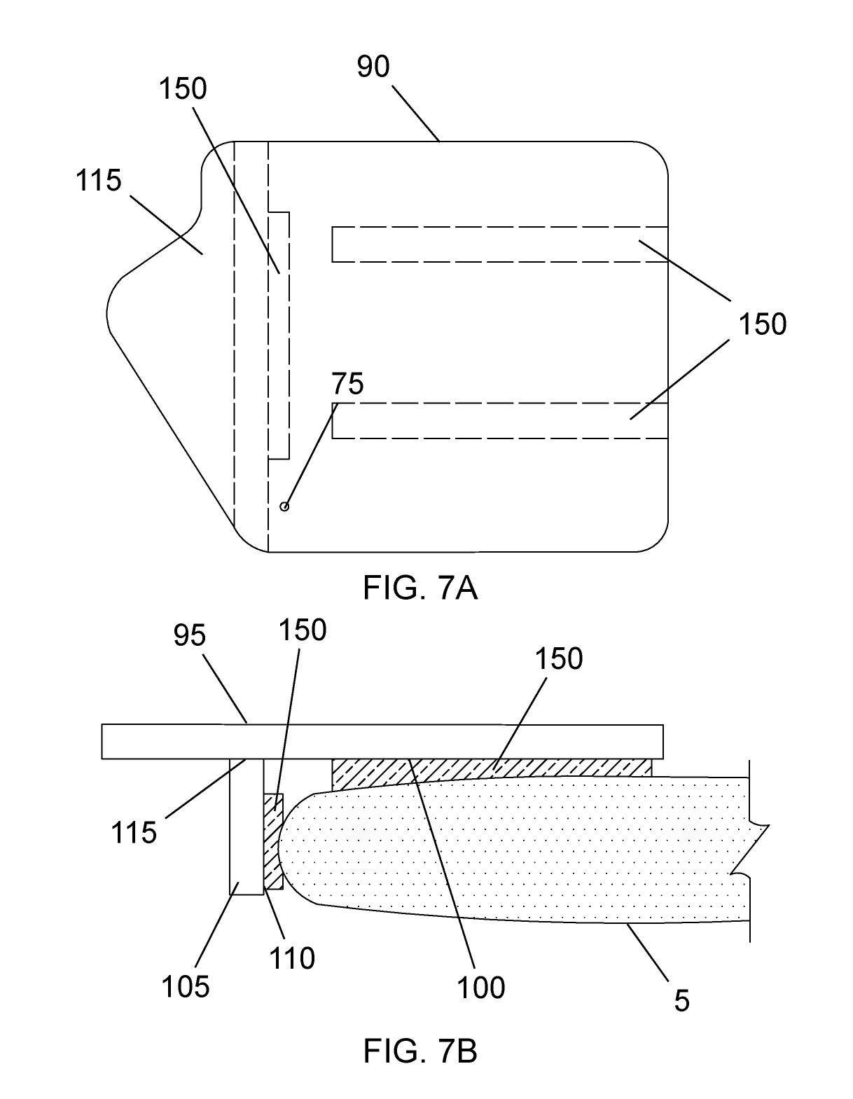

In one embodiment, the paddle board receiver assembly 85 is affixed to the paddle board 5 using a durable, water-resistant cordage material such as fiberglass strapping 125. Referring now to FIGS. 1 and 2, this strapping 125 is threaded through one or more paddle board connection points 120 and tightened around the circumference of the paddle board 5. This type of strapping provides excellent frictional engagement and permits the paddle board receiver assembly 85 to be easily and quickly attached or detached from the desired boarding area of the paddle board 5 without damaging or modifying the paddle board. FIGS. 6A and 6B show another embodiment offering a more permanent connection means using one or more mechanical fasteners. FIGS. 7A and 7B illustrate yet another embodiment using a frictional fastening means such hook and loop tape. Other means may be used to secure the receiver assembly 85 to the paddle board 5 including but not limited to glue, bolts, tie downs, screws or locking mechanisms.

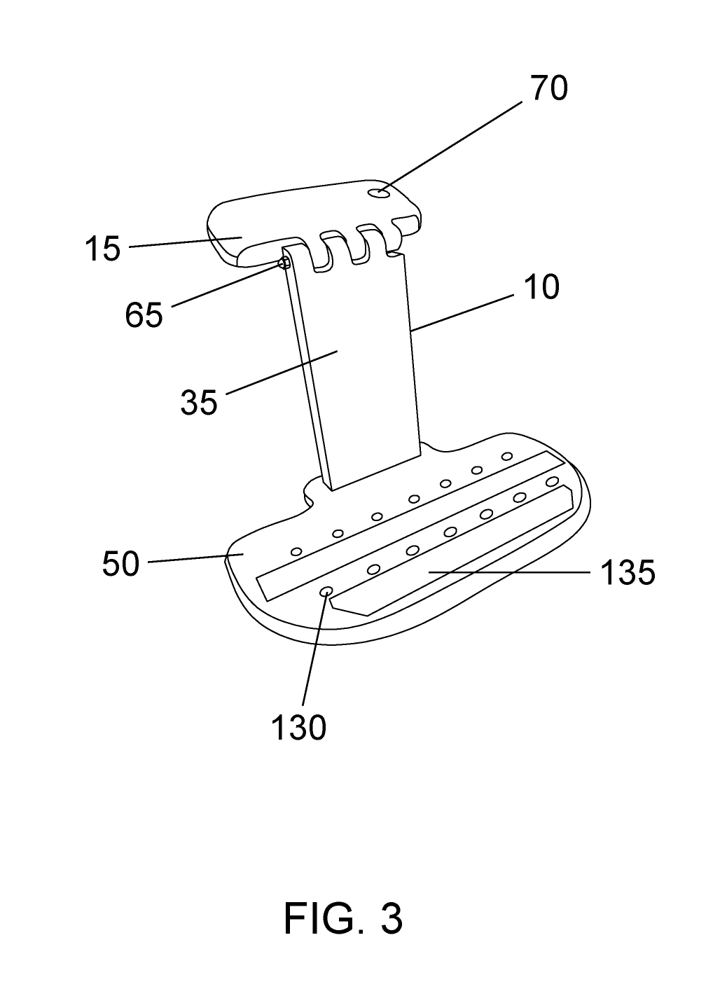

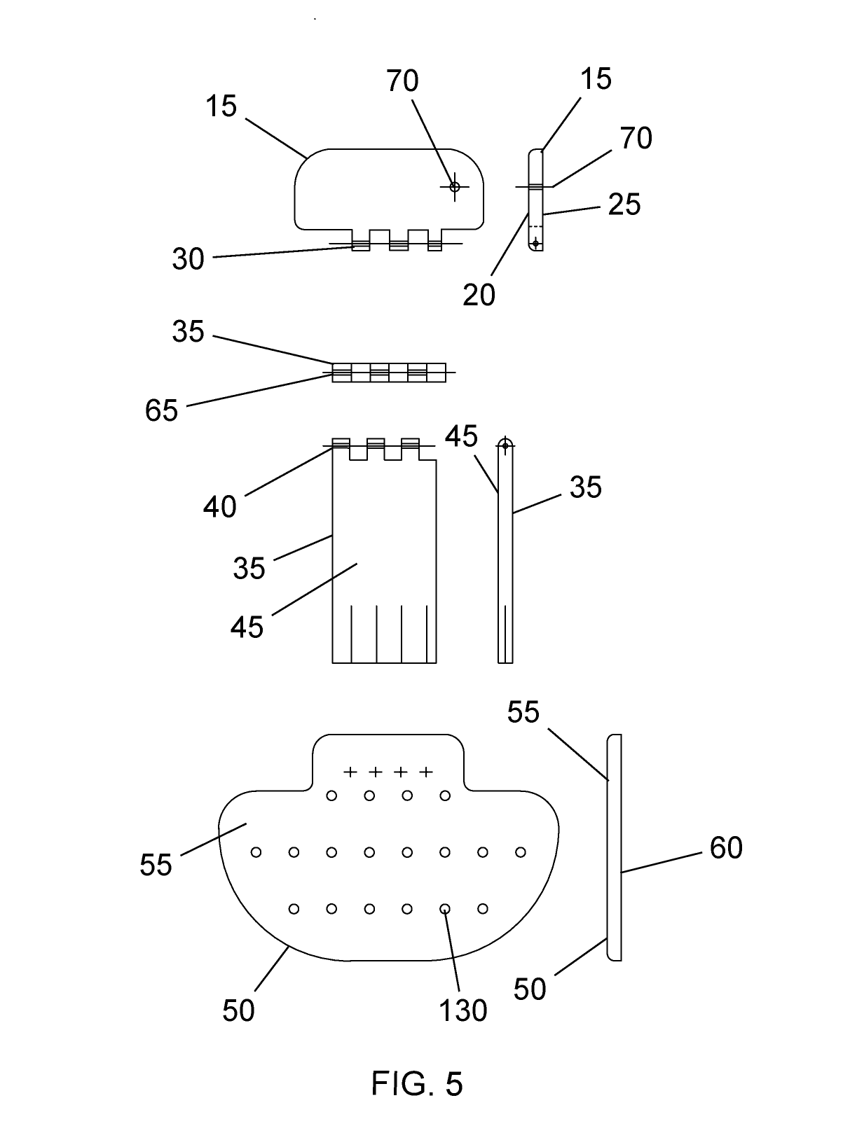

Referring now to FIGS. 3 and 5, the paddle board step assembly 10 is comprised of a connector platform 15, a riser 35 and an entry step 50 having a top face 55 and a bottom face 60. The connector platform 15 further comprising a top face 20, a bottom face 25, a linkage face 30 and an optional connector platform pivot point 70. The riser 35 further having a linkage face 40 and a tread face 45. Because the entry step 50 and riser 35 may be manufactured separately or as one piece, the tread face 45 of the riser 35 either extends from or is mechanically affixed to the top face 55 of the entry step 50 as shown in FIG. 5.

The riser 35, entry step 50 and receiver assembly platform 90 form the stair that assists the animal onto the paddle board 5. See FIG. 1. It should be noted that more than one step may be used by adding additional risers 35 and entry steps 50. The linkage face 40 of the riser 35 may be hingedly connected to the linkage face 30 of the connector platform 15, as shown in FIG. 3, allowing the step to flex slightly as the animal climbs aboard. This hinge attachment also enables the paddler to fold the step onto the paddle board 5 to decrease water resistance when not in use. In the preferred embodiment, a knuckle style hinge is used to connect the riser 35 to the connector platform 15 as shown in FIGS. 1, 3 and 5. This style of hinge is fairly closed, thereby minimizing the chance of pinching the animal during the boarding process. Those skilled in the art may use alternate forms of hinges to connect these components.

Looking once again at FIGS. 1 and 4A, the paddle board step assembly 10 may be pivotally connected to the paddle board receiver assembly 85. In the preferred embodiment, the connector platform pivot point 70 on the connector platform 15 is placed in alignment with the paddle board receiver pivot point 75 on the receiver assembly platform 90 and secured with a pivot point fastener 80 in such a way that the paddler can rotate or pivot the step system as needed to accommodate the boarding animal. The paddle board receiver platform 90 geometry is such that it extends beyond the paddle board to support the connector platform 15. It should be noted that the paddle board step assembly may alternatively be affixed to the paddle board receiver platform at two or more connection points using any one of a number of mechanical fastening means.

As noted above, the universal paddle board step and receiver should preferably be made of one or more materials that are substantially rigid, capable of withstanding repeated water exposure, and of sufficient strength to support the anticipated weight of the animal using the device. In addition, the paddle board step assembly 10 should be made to the appropriate scale to comfortably accommodate the size of the animal using this device. Fasteners and hinge hardware should preferably be made of corrosion proof or corrosion resistant materials of appropriate strength and durability.

Referring again to FIG. 1, the universal paddle board step and receiver may be made with additional features not discussed above. One such feature includes drainage holes 130 extending through the top face 55 and bottom face 60 of the entry step 50, allowing water to flow through the holes thereby lessening the drag. In another embodiment the top face 55 of the entry step 50 is fitted with non-slip material 135 providing the animal with additional traction as it boards the step.

While the above description contains many specifics, these should be considered exemplifications of one or more embodiments rather than limitations on the scope of the invention. As previously discussed, many variations are possible and the scope of the invention should not be restricted by the examples illustrated herein.

What is claimed is:

1. An apparatus for boarding animals onto a paddle board, the apparatus comprising a receiver platform mechanically affixed to a paddle board and a step assembly comprising a step, a riser and a connector platform, the step assembly being mounted to the receiver platform.

2. The apparatus according to claim 1, wherein the step assembly further comprises a hinge connecting the riser to the connector platform.

3. The apparatus according to claim 1, wherein the receiver platform is affixed to the paddle board by one or more straps.

4. The apparatus according to claim 1, wherein the receiver platform is affixed to the paddle board by hook and loop tape.

5. The apparatus according to claim 1, wherein the receiver platform is affixed to the paddle board by one or more anchoring means.

6. The apparatus according to claim 1, wherein the step comprises a non-slip surface.

7. The apparatus according to claim 1, wherein the step comprises drainage holes.

8. An apparatus for boarding animals onto a paddle board, the apparatus comprising a receiver platform mechanically affixed to a paddle board and a step assembly comprising a step, a riser and a connector platform, the step assembly being pivotally mounted to the receiver platform.

9. The apparatus according to claim 8, wherein the step assembly further comprises a hinge connecting the riser to the connector platform.

10. The apparatus according to claim 8, wherein the receiver platform is affixed to the paddle board by one or more straps.

11. The apparatus according to claim 8, wherein the receiver platform is affixed to the paddle board by hook and loop tape.

12. The apparatus according to claim 8, wherein the receiver platform is affixed to the paddle board by one or more anchoring means.

13. The apparatus according to claim 8, wherein the step comprises a non-slip surface.

14. The apparatus according to claim 8, wherein the step comprises drainage holes.
